(19) United States
(12) Patent Application Publication
(10) Pub. No.: US 2008/0164771 A1
(43) Pub. Date: Jul. 10, 2008

(54) High performance voice coil motor

(76) Inventor: David Huang, Changhua (TW)

Correspondence Address: DAVID HUANG, 235 Chung-Ho, Box 8-24, Taipei, omitted

(21) Appl. No.: 11/650,597

(22) Filed: Jan. 8, 2007

(51) Int. Cl. H02K 41/00

(52) U.S. Cl. 310/12

(57) ABSTRACT

A high performance voice coil motor comprises: a retaining seat having at least one magnetic unit; a movable seat installed within a receiving space of the retaining seat; the movable seat being installed with at least one coil set; the coil set being interacted with the magnetic unit as current flows through the coil set so that the movable seat moves with respect to the retaining seat; the magnetic unit having four poles so as to increase the density of magnetic lines. Each of four corners of the upper cover is extended with a supporting rod; and each of four sides of the movable seat is installed with a coil set which is adjacent to the magnetic unit. A lower side of the movable seat is installed with two lower elastic sheets; each lower elastic sheet has an electrode plate.

### FIELD OF THE INVENTION

The present invention relates to voice coil motors, and particularly to a high performance voice coil motor, wherein the efficiency of the magnetic field is increased so that the number of cycles of the coil set can be reduced and thus the cost is lowered.

### BACKGROUND OF THE INVENTION

The prior art voice coil motor is installed in a lens set for focusing magnetic units and coil set are installed between an upper elastic sheet and a lower elastic sheet. The direction of current is changed so as to change the moving direction of the coil. Thus the focus is adjusted.

In the prior art voice coil motor, a plurality of magnetic units each having two poles are installed and a coil set is installed in a movable seat of a lens set. The coil set is installed adjacent to the magnetic units. When current is actuated, the coil set will interact with the magnetic units so as to drive the movable seat to move.

However, referring to FIG. 8, in the prior art voice motor, the distribution of the magnetic lines is not effective so that if it is desired to enhance the magnetic strength so that the movable seat can be driven effectively, the number of cycles of the coil set must be increased or a great current is supplied or the magnetic units have great magnetic property. However, these induce the increment of cost and complexity of the structure.

### SUMMARY OF THE INVENTION

Accordingly, the primary object of the present invention is to provide a high performance voice coil motor, wherein the efficiency of the magnetic field is increased so that the number of cycles of the coil set can be reduced and thus the cost is lowered.

To achieve above objects, the present invention provides a high performance voice coil motor comprising: a retaining seat having at least one magnetic unit; a movable seat installed within a receiving space of the retaining seat; the movable seat being installed with at least one coil set; the coil set being interacted with the magnetic unit as current flows through the coil set so that the movable seat moves with respect to the retaining seat; the magnetic unit having four poles so as to increase the density of magnetic lines. Each of four corners of the upper cover is extended with a supporting rod; and each of four sides of the movable seat is installed with a coil set which is adjacent to the magnetic unit. A lower side of the movable seat is installed with two lower elastic sheets; each lower elastic sheet has an electrode plate; the two lower elastic sheets are electrically connected to the coil set and provide elastic resilient force to the movable seat. An upper end of the movable seat is installed with an upper elastic sheet for providing elastic resilient force to the movable seat. The retaining seat and movable seat are installed between an upper cover and a lower cover. A lower side of the retaining seat is installed with an insulated frame body for isolating the retaining seat and the two lower elastic sheets.

The various objects and advantages of the present invention will be more readily understood from the following detailed description when read in conjunction with the appended drawing.

### BRIEF DESCRIPTION OF THE DRAWINGS

FIG. 1 is an exploded perspective view of the high performance voice coil motor of the present invention.

FIG. 2 is a perspective view of the high performance voice coil motor of the present invention.

FIG. 3 is a schematic view showing the magnetic lines of the high performance voice coil motor of the present invention.

FIGS. 4 and 5 are schematic view showing the operation along line AA of FIG. 2.

FIGS. 6 and 7 are schematic view showing the operation along line BB of FIG. 2.

FIG. 8 is a schematic view showing the magnetic lines of the two-pole voice coil motor of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

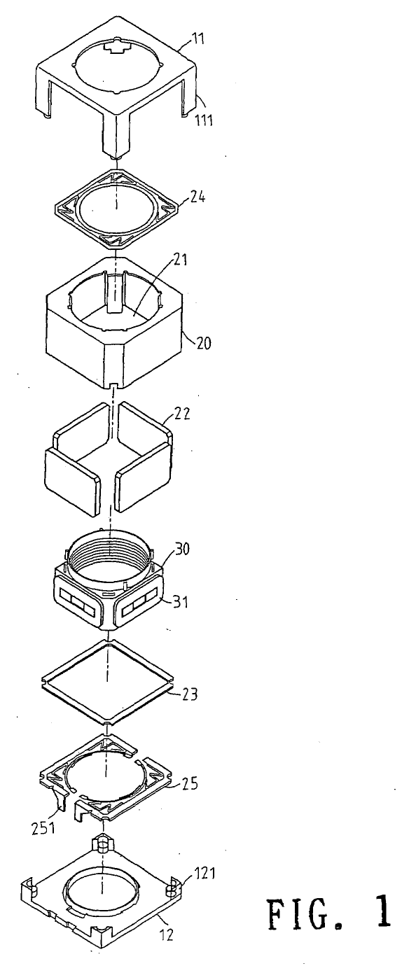

Referring to FIGS. 1 and 2, the high performance voice coil motor of the present invention is illustrated. The present invention has the following elements.

An upper cover 11 has an approximate rectangular shape. Each of four corners of the upper cover 11 is extended with a supporting rod 111.

A lower cover 12 has an approximate rectangular shape corresponding to that of the upper cover 11. Each of four corners of the lower cover 12 is formed with a supporting seat 121 for receiving a corresponding supporting rod 111 so as to combine the upper cover 11 and lower cover 12.

A retaining seat 20 has an approximate rectangular shape. Each corner of the retaining seat 20 is chambered for combining the supporting rod 111 of the upper cover 11. A center portion of the retaining seat 20 has a receiving space 21. Each of four inner walls of the retaining seat 20 is adhered with a magnetic unit 22 so that four poles are formed in the retaining seat 20. A bottom of the retaining seat 20 is engaged with an insulating frame body 23 for positioning the magnetic units 22. An upper elastic sheet 24 is located between the retaining seat 20 and the upper cover 11. Two lower elastic sheets 25 are located below the frame body 23. A lower cover 12 is installed between the two lower elastic sheets 25. The frame body serves to isolate the electricity of the retaining seat 20 and the two lower elastic sheets 25. Each lower cover 12 is installed with an electrode plate 251.

A movable seat 30 serves for installing a lens. Adjustment of the position of the movable seat 30 can adjust the focus of the lens. The movable seat 30 is installed in the receiving space 21 of the retaining seat 20. An upper side of the movable seat 30 is connected to the upper cover 11 by gluing and a lower side of the movable seat 30 is connected to the lower elastic sheets 25 by gluing. The movable seat 30 axially moves in the receiving space 21. Each of four sides of the movable seat 30 is installed with a coil set 31 which is adjacent to the magnetic unit 22. The movable seat 30 is electrically connected to the lower elastic sheets 25 so that current can be inputted through the lower elastic sheets 25. Thus the magnetic field from the coil set 31 is interacted with the magnetic field of the magnetic units 22 so as to drive the movable seat 30 to axially move within the receiving space 21. By the elastically resilient forces of the upper elastic sheet 24 and the lower elastic sheets 25, the movable seat 30 can axially move and resiliently move.

The assembly view of the present invention is illustrated in FIG. 2.

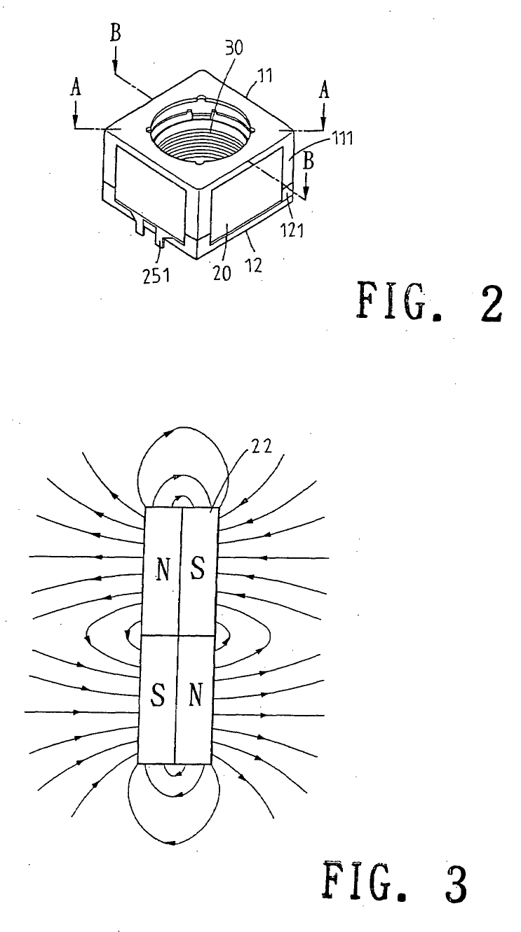

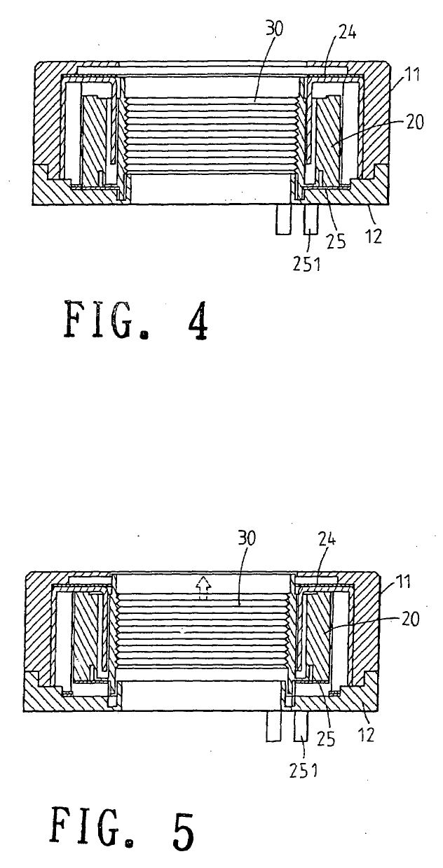

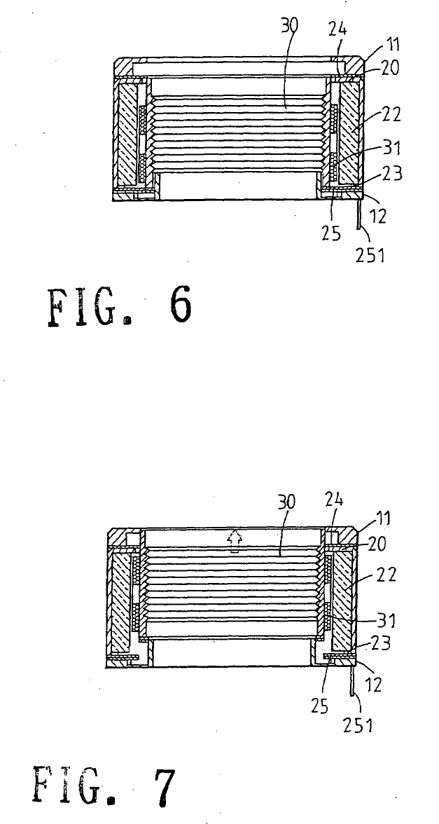

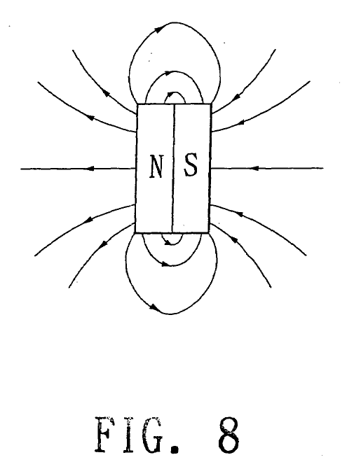

With reference to FIG. 3, the magnetic field of the magnetic units 22 of the present invention has four poles. A lateral surface of each magnetic unit 22 corresponding to the coil set 31 has dense magnetic lines. The adjustment of the movable seat 30 will adjust the density distribution of the magnetic lines so that the number of cycles of the coil and the current of the coil can be reduced. Thus the cost is saved and the power used is also reduced. With reference to FIGS. 4 to 7, in action of the present invention, external current flows into the two electrode plates 251 and the lower elastic sheets 25 to the coil set 31 of the movable seat 30. The direction of the current will determine the moving direction of the movable seat 30. The movement of the movable seat 30 will interact with the upper elastic sheet 24 and the lower elastic sheets 25. When the current of the coil set 3 1 is cut off, the movable seat 30 will return by the resilient force of the upper elastic sheet 24 and the lower elastic sheets 25.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A high performance voice coil motor comprising:
a retaining seat having at least one magnetic unit;
a movable seat installed within a receiving space of the retaining seat; the movable seat being installed with at least one coil set; the coil set being interacted with the magnetic unit as current flows through the coil set so that the movable seat moves with respect to the retaining seat; the magnetic unit having four poles so as to increase the density of magnetic lines.

2. The high performance voice coil motor as claimed in claim 1, wherein each of four corners of the upper cover is extended with a supporting rod; and each of four sides of the movable seat is installed with a coil set which is adjacent to the magnetic unit.

3. The high performance voice coil motor as claimed in claim 1, wherein a lower side of the movable seat is installed with two lower elastic sheets; each lower elastic sheet has an electrode plate; the two lower elastic sheets are electrically connected to the coil set and provide elastic resilient force to the movable seat.

4. The high performance voice coil motor as claimed in claim 1, wherein an upper end of the movable seat is installed with an upper elastic sheet for providing elastic resilient force to the movable seat.

5. The high performance voice coil motor as claimed in claim 1, wherein the retaining seat and movable seat are installed between an upper cover and a lower cover.

6. The high performance voice coil motor as claimed in claim 1, wherein a lower side of the retaining seat is installed with an insulated frame body for isolating the retaining seat and the two lower elastic sheets.
